(19) United States
(12) Patent Application Publication
(10) Pub. No.: US 2005/0239621 A1
(43) Pub. Date: Oct. 27, 2005

(54) Method for monitoring the position of a sheet transported in a folding machine

(75) Inventors: Klaus Stocklossa, Marbach (DE); Eberhard Krieger, Weinstadt-Struempfelbach (DE); Georg Dannemann, Backnang (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 11/110,692

(22) Filed: Apr. 21, 2005

(30) Foreign Application Priority Data
Apr. 22, 2004 (EP) 04 009 558.0

(51) Int. Cl. B31B 49/00

(52) U.S. Cl. 493/27

(57) ABSTRACT

In the method for monitoring the position of a sheet (36, 38, 48) transported in a folding machine, during the transport of the sheet (36, 38, 48), at a detection location, the positions of a sheet edge (37, 39, 49) running substantially in the transport direction (TR) are determined by a detection device (32, 34, 46). Measured values corresponding to the positions detected are then passed on to a processor device by the detection device (32, 34, 46). The processor device calculates a measured curve (MK1, MK2, MK3) on the basis of the detected measured values and the travel of the sheet (36, 38, 48) through the detection location and compares this with a previously determined reference curve (RK). The processor device outputs an error signal if the measured curve (MK1, MK2, MK3) deviates from the reference curve (RK).

### BACKGROUND OF THE INVENTION

1. Field of the Invention

The invention relates to a method for monitoring the position of a sheet transported in a folding machine.

2. Description of the Background Art

In a folding mechanism of a folding machine, a sheet is to be folded in such a way that, after the folding operation, all the edges of the sheet lie congruently on one another. A precondition for this is that the sheet has been cut absolutely rectangularly, the sheet is inserted at right angles to the longitudinal axes of the folding rollers, and the folding rollers exhibit the same pulling force over their working width. In the case of folding in a folding pocket, it is necessary that the folding pocket is not set obliquely with respect to the transport direction of the sheet and its clear width between the pocket rods is selected optimally. In addition, the sheet stop in the folding pocket must be set at right angles to the transport direction.

In order to correct possible faults, adjusting devices are provided at the appropriate points of the folding machine.

As a rule, not all the folded sheets of a job are cut with a cut on one cutting machine. Therefore, during the cutting of a job, it is possible for the rectangularity of the sheets and thus the folding result to change. In addition, a mechanical adjusting device, for example when its clamping to the folding machine is loosened, can change its position unnoticed. In addition, the position of a fold in a folding pocket depends on the speed. If the speed is changed during continuous production, the position of the fold changes, depending on the difference in speed, the sheet format, the folding length in the folding pocket and the characteristics of the paper.

A change in the folding result is detected by an operator of the folding machine only if the quality of the finally folded sheet is monitored continuously. Then, by using the folded product, the operator must detect the point in the folding machine at which a correction must be made in order that the folding quality is optimal again. This is very complicated and requires a very great deal of experience on the part of the operator.

### SUMMARY OF THE INVENTION

The invention is based on the object, by using constructionally simple means, of providing a method for monitoring the position of a sheet transported in a folding machine which makes it possible for the operator to quickly detect the source of a fault during the folding of a sheet and to carry out suitable corrective measures.

According to the invention, this object is achieved by a method for monitoring a position of a sheet transported in a folding machine, in which during transport of said sheet, at at least one detection location, positions of a sheet edge running substantially in a transport direction are determined by a detection device, measured values corresponding to said positions detected are passed on to a processor device by said detection device, said processor device calculates a measured curve on the basis of said detected measured values and said travel of said sheet through said detection location, said processor device compares said measured curve with a previously determined reference curve, said processor device outputs an error signal if said measured curve deviates from said reference curve.

As soon as the measured curve, determined during the passage of a sheet, deviates from the reference curve by more than a previously determined extent, the attention of the operator of the folding machine is drawn to the erroneous position of the sheet by the error signal from the processor device. The operator detects immediately the point in a folding machine at which the fault has first occurred. He can then take the necessary measures to rectify the erroneous position of the sheet.

In the event of a slight deviation of the measured curve from the reference curve, the correction can be carried out by the operator during operation.

If the deviations of the measured curve from the reference curve are too great, however, the processor device can give a command to stop the folding machine after the output of the error signal.

An intervention of an operator would not be possible if, following the output of the error signal, the drives of the folding machine that are responsible for the deviation are driven automatically by the processor device in such a way that, in the case of the following sheets, the measured curve and the reference curve coincide.

The detection device in a preferred embodiment is formed by a light curtain which, depending on the coverage by the sheet, passes on an electrical signal as measured value to the processor device. Such a light curtain is, for example, the FAV30-01 photo sensor with analog output from SensoPart. The electrical signal can be a voltage value, for example from 0 to 10 V, a current value, for example from 0 to 20 mA, a serial data interface, a parallel interface or the like.

The detection and evaluation can, however, also be carried out by an image processing system comprising camera, processor device and suitable software.

The reference curve is preferably determined during the passage of a calibration sheet which is optimally folded after passing through the folding machine.

### BRIEF DESCRIPTION OF THE DRAWINGS

Exemplary embodiments of the invention will be explained in more detail below using drawings, in which

FIG. 1 shows, in schematic form, a plan view of a first embodiment of a folding machine having two folding mechanisms,

FIG. 2 shows a pocket folding mechanism in schematic form,

FIG. 3 shows a U-S reference curve of a calibration sheet,

FIG. 4 shows a first measured curve as compared with the reference curve,

FIG. 5 shows a second measured curve as compared with the reference curve,

FIG. 6 shows a third measured curve as compared with the reference curve,

FIG. 7 shows, in schematic form, a plan view of a second embodiment of a folding machine having two folding mechanisms.

### DETAILED DESCRIPTION OF THE INVENTION

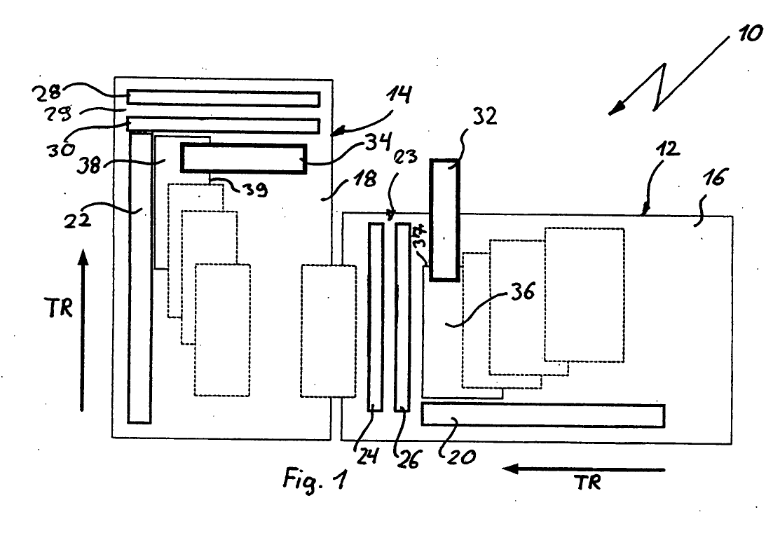

The folding machine shown in FIG. 1 has a first folding mechanism 23 having two folding rollers 24, 26 and a second folding mechanism 29 having folding rollers 28, 30 connected downstream of the first folding mechanism 23. Arranged upstream of the first folding mechanism 23 is a first inclined roller table which, in a known manner, contains an alignment rule 20 which extends in the transport direction TR1 of the sheet 36. In the ideal case, the sheet 36 will be brought into contact with the alignment rule 20 by the first inclined roller table 16 and then guided in the transport direction TR1 between the folding rollers 24, 26 and folded by the latter. After the passage through the folding rollers 24, 26, the folded sheet 39 is conveyed onto a second inclined roller table 18, of which the transport direction TR2 runs at right angles to the transport direction TR1 of the first inclined roller table 16. By means of the inclined rollers, the sheet 39 is brought into contact with an alignment rule 22 and then guided between the folding rollers 28, 30 of the second folding mechanism 29 and folded once more.

Immediately before the folding rollers 24, 26 of the first folding mechanism 23 there is arranged a light curtain 32 as a detection device, whose longitudinal direction runs at right angles to the longitudinal direction of the alignment rule 20. In the region in which the light curtain 32 is arranged, the sheet 36 should already be resting on the alignment rule 20, in order then to be introduced between the folding rollers 24, 26 in the transport direction TR1.

The light curtain 32 is arranged in such a way that it extends in the direction of the alignment rule 20 beyond the sheet edge 37 facing away from the alignment rule 20, in order to be able to detect the sheet edge 37. Depending on the coverage of the light curtain 32 by the sheet 36, the light curtain 32 passes on a measured value to a processor device (not shown). The light curtain is, for example, an FAV30-01 photosensor with analog output from the SensoPart company. This photosensor passes on a voltage of 0 to 10 V to the processor device, depending on the coverage by the sheet 37.

A similar light curtain 34 is arranged in front of the second folding mechanism 29.

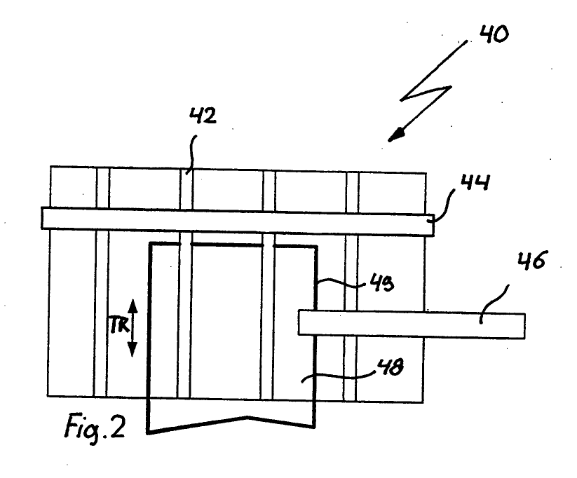

FIG. 2 shows, in schematic form, a folding pocket 40 having a plurality of pocket rods 42 forming a pocket gap and a stop 44 limiting the travel of a sheet running into the folding pocket 48. Shortly after the pocket inlet, parallel to the stop 44, there is arranged a light curtain 46, which extends beyond the right-hand edge 49 of a sheet in FIG. 2. As indicated by the double arrow TR, the sheet 48 is inserted until it strikes the stop 44. The sheet 48 is then conveyed out of the folding pocket 40 again.

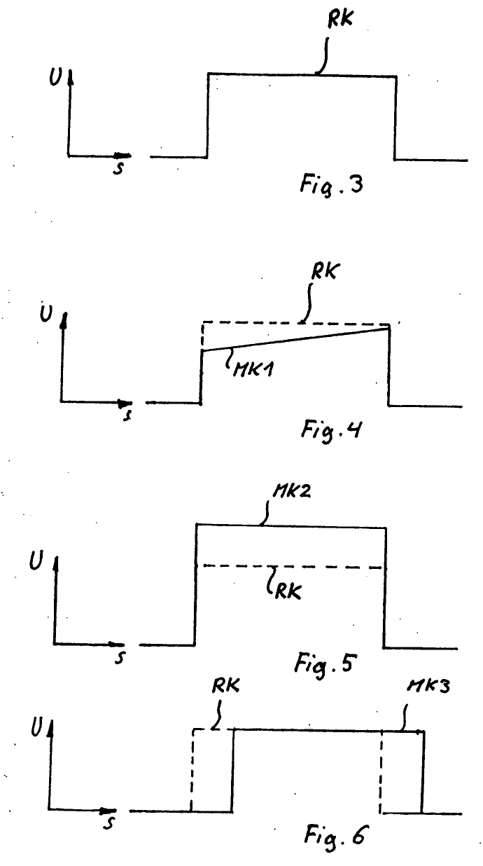

FIG. 3 shows by way of example a U(voltage)-S(travel) reference curve RK of a calibration sheet, which is determined by the processor device by using the measured values which had been determined by the optical sensor 32 during the passage of a calibration sheet.

This is an optimal U-S curve, which leads to exact folding of the calibration sheet. The voltage U is passed on to the processor device by the light curtain. The travel S is determined via a rotary encoder on the appropriate folding mechanism. This rotary encoder is firmly connected to the sheet transport system. Each pulse on the rotary encoder corresponds to a specific travel of the sheet transport system. The processor device can therefore determine the sheet travel S and thus the U-S curve from the number of pulses.

FIG. 4 shows a measured curve MK1 from a sheet 36 passing through obliquely in the region of the light curtain 32. The measured curve MK1 shows that the sheet edge 37, as it runs through the light curtain 32, is located closer to the alignment rule 20 than the sheet edge 37 of the calibration sheet. At the end of the passage of the sheet 36, the distance of the sheet edge 37 corresponds substantially to the distance of the sheet edge of the calibration sheet.

The measured curve MK2 shown in FIG. 5 reveals that the sheet running direction of the sheet 36 is parallel to the sheet running direction of the calibration sheet. However, the sheet 36 covers the light curtain 32 further than the calibration sheet, so that a higher voltage is output by the light curtain 32. The sheet 36 corresponding to the measured curve MK2 is thus at a distance from the alignment rule 20.

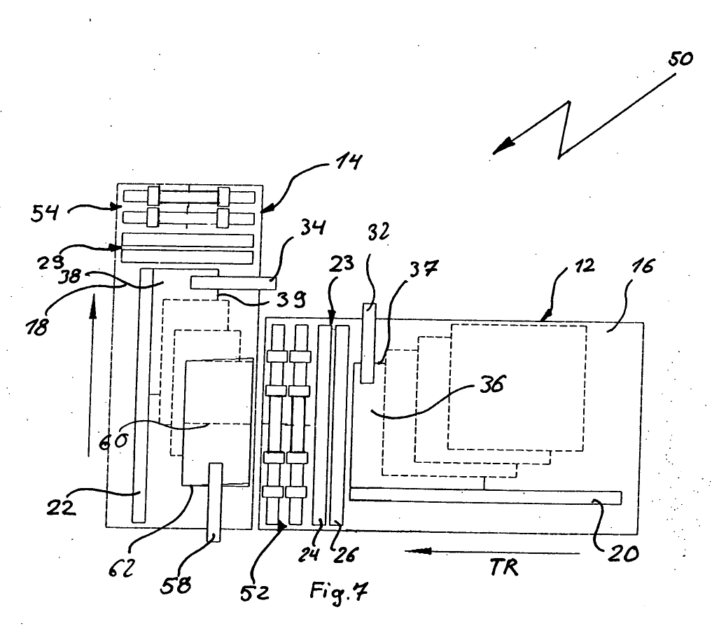

FIG. 6 shows a measured curve MK3 from a sheet 36 which is transported exactly along the alignment rule 20 and the width of which corresponds to the width of the calibration sheet. However, the leading sheet edge of the incoming sheet 36 runs into the light curtain 32 at a later time than that of the calibration sheet.

If the processor device determines a measured curve MK1, MK2 or MK3, it outputs an error signal which indicates that the sheet 36 is not transported in accordance with the calibration sheet. After the error signal has been output, by taking account of the differences of the measured curves MK1, MK2 and MK3 in relation to the reference curve RK, the suitable measures can be taken by an operator or, if appropriate, automatically.

The second embodiment of the folding machine 50, shown in FIG. 7, differs from the folding machine shown in FIG. 1 in that the pairs of folding rollers 23, 29 in each case have a pair of knife cylinders 52 and 54 arranged after them, by means of which perforations or creases can be formed in a folded sheet folded by the pairs of folding rollers 23, 29, weakening the sheet along a fold line.

As viewed in the sheet transport direction TR, a further light curtain 58 is provided after the pair of knife cylinders 52 of the first folding mechanism 12, such that it detects the lateral sheet edge 62 of a sheet 60 running out of the first folding mechanism 12, which has been folded by the pair of folding rollers 23 and perforated by the pair of knife cylinders 52. Since the lateral sheet edge 62 always runs parallel to the perforation or crease lines formed by the pair of knife cylinders 52, it is possible to use the light curtain 58 in the manner described by using FIGS. 3 to 6 to detect whether the perforation or crease lines run exactly.

Correction of oblique perforation lines is normally carried out by pulling a sheet diverter (not shown) arranged upstream of the pair of knife cylinders 52 in the folding mechanism 12 to the leading side. The pulling action forces a lengthening of the travel when passing through the sheet diverter, and therefore the lead is compensated for. The use of the light curtain 58 after the pair of knife cylinders 52 permits the monitoring of the straight exit of the emerging lateral sheet edge 62 and therefore the perforation line produced in the pair of knife cylinders 52.

Any deviation of a determined measured curve from a reference curve can be signaled to the operator by means of an error signal from the processor device, so that the appropriate sheet diverter can be pulled.

1. A method for monitoring a position of a sheet transported in a folding machine, in which
during transport of said sheet, at at least one detection location, positions of a sheet edge running substantially in a transport direction are determined by a detection device,
measured values corresponding to said positions detected are passed on to a processor device by said detection device,
said processor device calculates a measured curve on the basis of said detected measured values and said travel of said sheet through said detection location,
said processor device compares said measured curve with a previously determined reference curve,
said processor device outputs an error signal if said measured curve deviates from said reference curve.

2. The method as claimed in claim 1, wherein, in the event of a slight deviation of said measured curve from said reference curve, advice for an operator of said folding machine is output after said output of said error signal.

3. The method as claimed in claim 1, wherein, in the event of a large deviation of said measured curve from said reference curve said folding machine is stopped after said output of said error signal.

4. The method as claimed in claim 1, wherein, after said output of said error signal, drives of said folding machine that are responsible for deviation are driven in such a way that, in the case of the following sheets, said measured curve and said reference curve coincide.

5. The method as claimed in claim 1, wherein said detection device is formed by a light curtain, which passes on a voltage value as measured value to said processor device as a function of coverage by said sheet.

6. The method as claimed in claim 1, wherein said detection device is formed by a light curtain, which passes on a current value, a serial data interface or a parallel interface as measured value to said processor device as a function of coverage by said sheet.

7. The method as claimed in claim 1, wherein said detection device is formed by a camera which is connected to an image processing system.

8. The method as claimed in claim 1, wherein said reference curve is determined during passage of a calibration sheet.
